(19) United States
(12) Patent Application Publication
(10) Pub. No.: US 2018/0258945 A1
(43) Pub. Date: Sep. 13, 2018

(54) TURBOCHARGER COMPRESSOR IMPELLER WITH SERRATED LEADING EDGES

(71) Applicant: BorgWarner Inc., Auburn Hills, MI (US)

(72) Inventors: Robert Dirk Lotz, Asheville, NC (US); Kenneth Lee Davis, Mills River, NC (US); John Paul Watson, Arden, NC (US); Gordon Jenks, Hendersonville, NC (US)

(73) Assignee: BorgWarner Inc., Auburn Hills, MI (US)

(21) Appl. No.: 15/457,539

(22) Filed: Mar. 13, 2017

(51) Int. Cl. F04D 29/28; F04D 17/10; F04D 25/04; F02B 37/00; B23C 3/18

(52) U.S. Cl. CPC F04D 29/284; F04D 17/10; F04D 25/04; B23C 2220/32; B23C 3/18; B23C 2215/44; B23C 2220/605; F02B 37/00

(57) ABSTRACT

A turbocharger is disclosed. The turbocharger may comprise a turbine, and a compressor having a radial impeller. The radial impeller may include a body having a hub and a plurality of main blades extending from the hub. Each of the main blades may have a leading edge. The turbocharger may further comprise a plurality of serrations extending along the leading edge of each of the main blades, and a shaft interconnecting the compressor and the turbine. The body of the impeller may be formed by flank milling, and the serrations extending along the leading edges of the main blades may be formed by point milling.

### TECHNICAL FIELD

The present disclosure generally relates to turbochargers and, more specifically, to turbocharger compressor impellers with serrated leading edges and to methods of fabricating turbocharger compressor impellers with serrated leading edges.

### BACKGROUND

Turbochargers are used in numerous applications such as automotive, marine, and aerospace applications. Turbochargers operate by forcing more intake air into a combustion chamber of an internal combustion engine to improve the efficiency and power output of the engine. A turbocharger may generally include a compressor connected to a turbine by an interconnecting shaft. The turbine may extract energy from the flow of exhaust gases to drive the compressor via the interconnecting shaft, while the compressor may increase the pressure of intake air for delivery to the combustion chamber. The compressor may include a radial impeller that accelerates the intake air and expels the air in a radial direction, and a diffuser that slows down the expelled air to cause a pressure rise. The radial impeller may include a hub and a plurality of blades that rotate to increase the velocity of the intake air. Radial impellers of turbocharger compressors may be fabricated using flank milling which uses the side of a flank mill cutter to machine the features of the impeller. Flank milling may be more efficient and cost-effective than point milling, which uses a ball end of a point mill cutter for machining.

While effective, the operating range of turbocharger compressors may be limited to certain mass flow rates and pressure ratios outside of which the compressor may exhibit undesirable choke or surge behavior. In particular, the operating range of a compressor may be characterized by a map of operable mass flow rates and pressure ratios, with right and left boundaries respectively defining the choke and surge lines of the compressor. The choke line defines the maximum mass flow rate of the compressor, and the surge line defines the minimum mass flow rate of the compressor. Compressor surge occurs when the direction of flow through the compressor reverses to relieve pressure at the compressor outlet under low mass flow rate and high pressure ratio conditions. That is, at certain low mass flow rates and high pressure ratios, the flow can no longer adhere to the suction side of the blades, interrupting the discharge process and resulting in a pressure build up at the compressor outlet. The direction of air flow through the compressor may be reversed until a stable pressure ratio is reached, at which point the air flow proceeds in the forward direction again. This flow instability continues within the surge range of the compressor map and produces a noise known as “surging”. Operating the turbocharger in surge for extended periods is undesirable, and may negatively impact the performance of the turbocharger. As such, engineers are seeking strategies to expand the permissible operating range of turbocharger compressors as a way to reduce compressor surge.

U.S. Patent Application Number 2009/0074578 discloses a turbine rotor blade for a wind turbine having tubercles along the leading edge of the blade to provide the rotor with enhanced lift, reduced drag, and improved resistance to stall. However, the application does not address the issue of reducing surge in turbocharger compressors. Thus, there is a need for improved turbocharger compressor designs that exhibit reduced surge behavior.

### SUMMARY

In accordance with one aspect of the present disclosure, a turbocharger is disclosed. The turbocharger may comprise a turbine, and a compressor having a radial impeller. The radial impeller may include a hub and a plurality of main blades extending from the hub. Each of the main blades may have a leading edge. The turbocharger may further comprise a plurality of serrations extending along the leading edge of each of the main blades. In addition, the turbocharger may further comprise a shaft interconnecting the compressor and the turbine.

In accordance with another aspect of the present disclosure, a radial impeller for a turbocharger compressor is disclosed. The radial impeller may have a body including a hub and a plurality of main blades extending from the hub. Each of the main blades may have a leading edge extending from a shroud end to a hub end. The radial impeller may be fabricated by a method comprising machining the body of the radial impeller by flank milling, and forming serrations extending along each of the leading edges of the main blades by point milling.

In accordance with another aspect of the present disclosure, a method of fabricating a radial impeller for a turbocharger compressor is disclosed. The radial impeller may have a body including a hub and a plurality of main blades extending from the hub. The method may comprise machining the body of the radial impeller by flank milling, and forming serrations extending along the leading edges of each of the main blades by point milling. The flank milling and the point milling may be carried out using a 5-axis milling machine.

These and other aspects and features of the present disclosure will be more readily understood when read in conjunction with the accompanying drawings.

### BRIEF DESCRIPTION OF THE DRAWINGS

FIG. 1 is a partial cross-sectional view of a turbocharger having a compressor and a turbine, constructed in accordance with the present disclosure.

FIG. 2 is perspective view of a radial impeller of the turbocharger compressor having main blades with serrated leading edges, constructed in accordance with the present disclosure.

FIG. 3 is a top view of the radial impeller of FIG. 2, constructed in accordance with the present disclosure.

FIG. 4 is an expanded view of detail 4 of FIG. 3, constructed in accordance with the present disclosure.

FIG. 5 is a perspective view of the radial impeller similar to FIG. 2, but having splitter blades with serrated leading edges, constructed in accordance with the present disclosure.

FIG. 6 is a perspective view of an exemplary 5-axis milling machine, constructed in accordance with the present disclosure.

FIG. 7 is a flowchart illustrating machining instructions for the 5-axis milling machine that may be used to fabricate the radial impeller, in accordance with the present disclosure.

FIG. 8 is a perspective view of machining a body of the impeller by flank milling, in accordance with a method of the present disclosure.

FIG. 9 is a perspective view of forming serrations at the leading edge of one of the main blades by point milling, in accordance with a method of the present disclosure.

FIG. 10 is a schematic representation of machining one of the serrations at the leading edge by point milling, in accordance with a method of the present disclosure.

FIG. 11 is a flow chart of a method that may be used to fabricate the radial impeller with serrated leading edges, in accordance with a method of the present disclosure.

FIG. 12 is a flow chart of a series of steps that may be involved in forming the serrations at the leading edges by point milling, in accordance with a method of the present disclosure.

### DETAILED DESCRIPTION

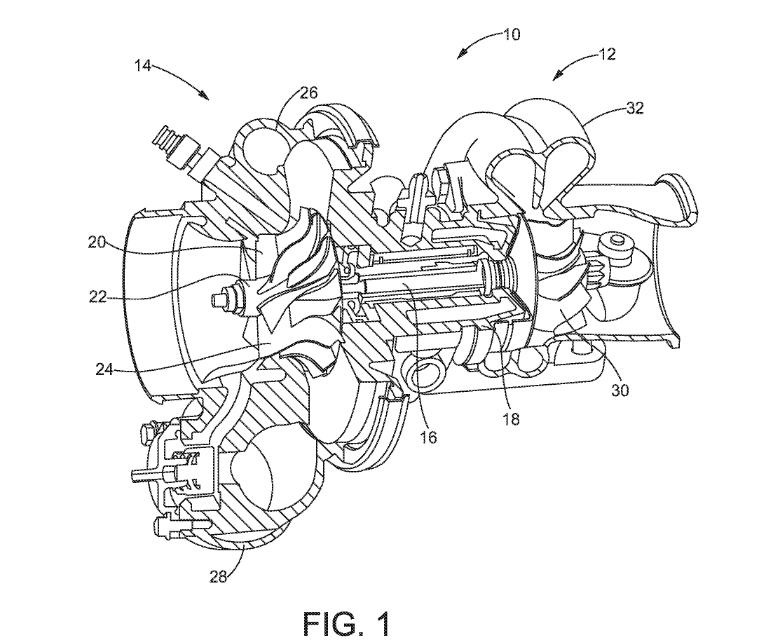

Referring now to the drawings, and with specific reference to FIG. 1, a turbocharger 10 is shown. The turbocharger 10 may operate by forcing more intake air into a combustion chamber of an internal combustion engine, allowing increased engine efficiency and power output. For example, the turbocharger 10 may be a component of an automotive vehicle, although it may be used in other applications as well such as, but not limited to, marine or aircraft applications. The turbocharger 10 may include a turbine 12 and a compressor 14 interconnected through a shaft 16 encased in a center housing 18. The compressor 14 may include a compressor wheel (or a radial impeller) 20 having a hub 22 and blades 24 extending from the hub 22, a diffuser 26, and a compressor outlet 28 through which compressed air from the compressor flows to the engine for combustion. The turbine 12 may include a turbine wheel 30 and a turbine housing 32 having an inlet through which exhaust gases from the engine flow to drive the rotation of the turbine wheel 30. The rotating turbine wheel 30 may, in turn, drive the rotation of the compressor radial impeller 20 via the interconnecting shaft 16. Rotation of the blades 24 of the radial impeller 20 may increase the velocity of intake air, and the high velocity air may be expelled into the diffuser 26. In the diffuser 26, the air may slow down, causing the pressure to rise to provide the compressed air for delivery to the engine through the outlet 28.

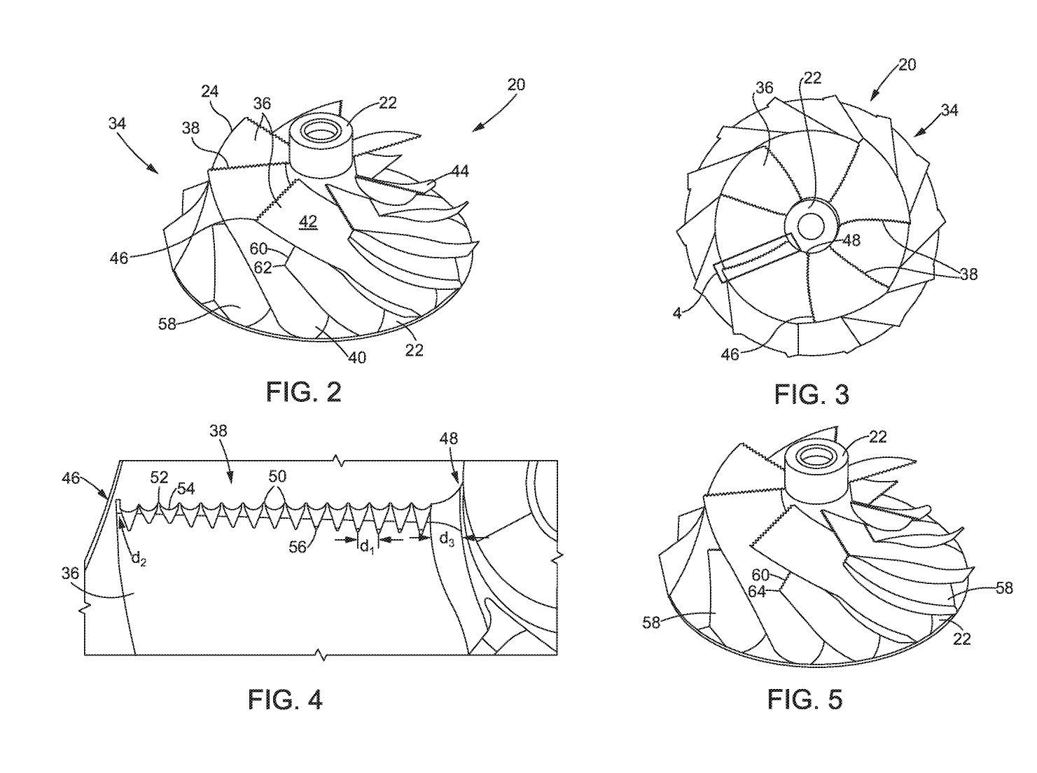

Turning to FIGS. 2-3, the radial impeller 20 of the compressor 14 is shown in isolation. The radial impeller 20 may have a body 34 defining the hub 22 and the blades 24. The blades 24 of the compressor 14 may include a plurality of main blades 36 each having a leading edge 38, a trailing edge 40, a pressure side 42, and a suction side 44. The leading edges 38 may extend radially between a shroud end 46 and a hub end 48 (also see FIG. 4). The shroud end 46 may be a portion of the leading edge 38 nearest to a shroud (not shown) located radially outward of the impeller 20, while the hub end 48 may be a portion of the leading edge 38 nearest to the hub 22.

Extending along each of the leading edges 38 between the shroud end 46 and the hub end 48 may be a plurality of serrations 50, as shown in FIG. 4. Each of the serrations 50 may include a tip 52 and a crevice 54 adjacent to the tip 52. The serrations 50 extending along the leading edge 38 may be immediately adjacent to each other and may have a uniform shape and size, and may be identical when viewed from the pressure side 42 and the suction side 44 of the blade 36. Each of the serrations 50 may have a radius of less than about 1 millimeter, although the radii of the serrations 50 may be greater than 1 millimeter in alternative designs. In one arrangement, each of the serrations 50 may have a radius of about 0.5 millimeter, and the serrations 50 may be spaced by a distance (d₁) of about 1 millimeter as measured between two centerlines 56 of two neighboring serrations 50. Furthermore, the leading edges 38 of the main blades 36 may be non-serrated and smooth near the hub end 48 and the shroud end 46. That is, the serrations 50 extending along the leading edge 38 may begin at a distance (d₂) from the shroud end 46 and may end at a distance (d₃) from the hub end 48. For example, the serrations 50 may begin about 0.5 millimeter from the shroud end 46 and end about 2 to 3 millimeters from the hub end 48. However, in alternative designs, the serrations 50 may be spaced apart and/or have varying shapes and sizes. In addition, the serrations 50 may extend all the way to the shroud end 46 and/or to the hub end 48 in other arrangements.

While not being bound by any particular theory, applicants contemplate that the serrations 50 may produce two counter-rotating air vortices emanating from each of the tips 52 during operation. The counter-rotating vortices may flow over the main blade surfaces to prevent or delay flow separation and soften out the surge behavior of the compressor 14. For instance, the counter-rotating vortices may flow over the suction side 44 of the main blades 36 to prevent flow separation. As such, the serrations 50 may extend the operating range of the compressor 14, enabling the compressor 14 to operate at lower mass flow rates with reduced surge behavior. It is also expected that the serrations 50 may reduce surge-induced noise in the turbocharger 10.

As shown in FIG. 2, the radial impeller 20 may further comprise a plurality of shorter splitter blades 58 extending from the hub 22 that alternate in sequence with the plurality of main blades 36. Each of the splitter blades 58 may have a leading edge 60 extending from a shroud end 62 to a hub end (not shown). The leading edges 60 may be smooth or non-serrated, as shown in FIG. 2. Alternatively, as shown in FIG. 5, a plurality of serrations 64 may extend along the leading edges 60 of the splitter blades 58. The serrations 64 of the splitter blades 58 may contribute to flow separation delay and softening of the surge behavior of the compressor 14. Similar to the serrations 50 of the main blades 36, the serrations 64 of the splitter blades 58 may be immediately adjacent to each other, and may be uniform in shape with uniform radii. For example, each of the serrations 64 may have a radius of less than about 1 millimeter (e.g., about 0.5 millimeter). In other embodiments, the serrations 64 may have variable shapes and sizes. Furthermore, each of the leading edges 60 of the splitter blades 58 may be serrated along the entire length of the leading edge 60, or the leading edge 60 may be non-serrated and smooth near the shroud end and/or near the hub end. In other designs, the radial impeller 20 may lack splitter blades.

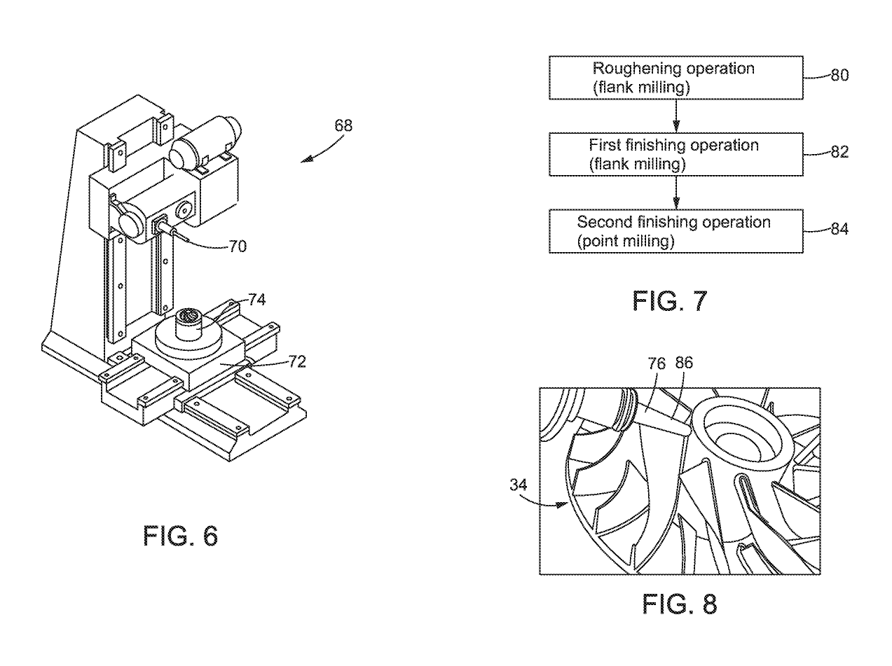

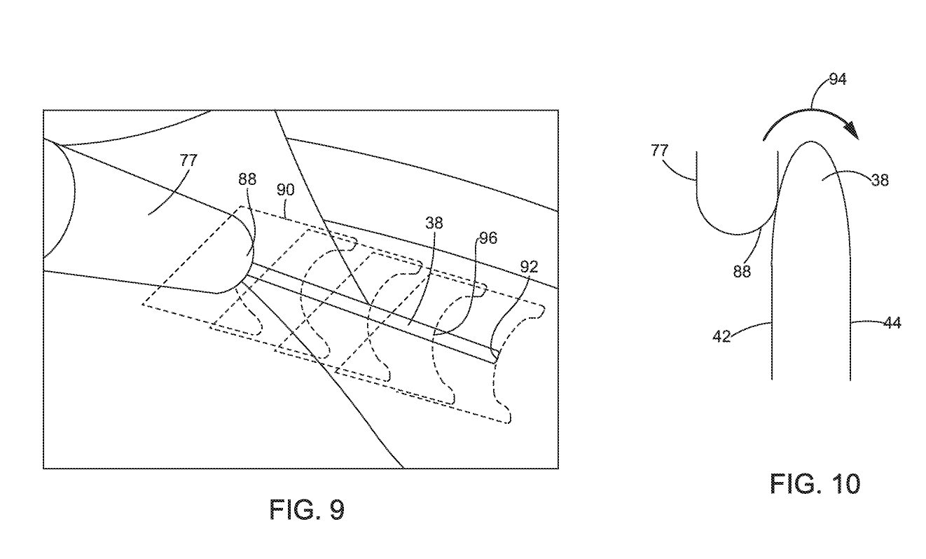

The radial impeller 20 may be machined using a 5-axis milling machine 68, as shown in FIG. 6. It is noted that the 5-axis milling machine 68 of FIG. 6 is merely exemplary, and may have various alternative configurations in practice. The 5-axis milling machine 68 may include a mill cutter 70 and a workpiece table 72 for supporting a workpiece 74. The mill cutter 70 may be a flank mill cutter 76 (see FIG. 8) or a point mill cutter 77 (see FIG. 9), as explained in further detail below. The 5-axis milling machine 68 may automate material removal from the workpiece 74 to form the radial impeller 20. As is understood by those with ordinary skill in the art, the 5-axis milling machine 68 may be capable of moving the workpiece 74 and the mill cutter 70 in five directions to allow the cutter 70 to approach the workpiece 74 from all directions. That is, the machine 68 may move the workpiece 74 in two directions (X and Y), while the mill cutter 70 may move up and down in the Z direction and rotate on two rotary axes (A and B) to allow complex geometries to be fabricated.

The shape of the radial impeller 20 may be designed using computer automated design (CAD) software (or other suitable software), and the shape of the radial impeller 20 from the CAD software may be converted into milling instructions for the 5-axis machine 68 using computer automated manufacturing (CAM) software (or other suitable software). The milling instructions may include the paths that the mill cutter 70 (i.e., the flank mill cutter 76 or the point mill cutter 77) follows over the workpiece 74 to remove material to obtain the final structure of the radial impeller 20. As shown in FIG. 7, the milling instructions may include a roughening operation 80 followed by first and second finishing operations 82 and 84. The roughening operation 80 may be carried out by flank milling using the flank mill cutter 76, and may involve removing larger pieces of material from the work piece 74 to carve the general shape of the body 34 of the radial impeller 20. The first finishing operation 82 may also be carried out by flank milling using the flank mill cutter 76, and may involve finishing passes that run slower to detail finer features and curves of the blades 24. The second finishing operation 84 may be carried out by point milling using the point mill cutter 77 to machine the serrations 50 along the leading edges 38 of the main blades 36 (see FIGS. 9-10 and further details below). The instructions may include definitions for slightly elongated leading edges that are subsequently shortened by point milling during the second finishing operation 84. Thus, as opposed to current procedures for machining compressor radial impellers which use only flank milling for the finishing operation, the present disclosure includes a modified finishing operation that installs the serrations 50 by point milling. Accordingly, the majority of the machining operation may benefit from the efficiency and lower cost of flank milling, with point milling only being used to install the serrations in a final finishing step.

Machining of the body 34 of the radial impeller 20 by flank milling is depicted in FIG. 8. The flank milling may involve machining the features of the radial impeller 20 using a side 86 of the flank mill cutter 86 as shown. Flank milling may be carried out for both the roughening operation 80 and the first finishing operation 82 that machines the finer details of the blade features.

Machining of the serrations 50 at the leading edges 38 by point milling is illustrated in FIGS. 9-10. The point milling may be carried out by contacting a ball end 88 of the point mill cutter 77 with the leading edges 38 of the main blades 36. The ball end 88 of the point mill cutter 77 may have a diameter that defines the radii of the serrations 50. For example, if each of the serrations 50 have a radius of about 0.5 millimeter, the ball end 88 of the point mill cutter 77 may have a diameter of about 1 millimeter. The point mill cutter 77 may follow a path 90 when machining the serrations 50, as shown in FIG. 9. Specifically, the ball end 88 of the point mill cutter 77 may start at a first radial location 92 of the leading edge 38 and move around the radius of the leading edge 38 at the first radial location 92 in or more passes 94 to form one of the serrations 50 (see FIG. 10). For example, the serration 50 may be formed in one to three passes 94, although more or less passes may be used in some cases. While forming the serration 50, the ball end 88 of the point mill cutter 77 may stay in contact tangent to the surface of the leading edge 38 all the way around (see FIG. 10). After forming the serration 50 at the first radial location 92, the point mill cutter may shift radially along the leading edge 38 to a second radial location 96 to form another one of the serrations 50 at the second radial location 96 in one or more passes 94. The process may repeat to form the desired number serrations 50 along the leading edge 38.

The point mill cutter 77 may move radially inward from the shroud end 46 to the hub end 48 while forming the serrations 50 such that the first serration is machined near the shroud end 46 and the last serration is machined near the hub end 48 (see FIG. 9).

Alternatively, the point mill cutter 77 may move radially outward from the hub end 48 to the shroud end 46 when forming the serrations. In addition, the ball end 88 of the point mill cutter 77 may move from the pressure side 42 to the suction side 44 during the pass 94 around the radius of the leading edge 38 (see FIG. 10), although it may move from the suction side 44 to the pressure side 42 in alternative arrangements.

### INDUSTRIAL APPLICABILITY

In general, the teachings of the present disclosure may find broad applicability in many industries including, but not limited to, automotive, marine, aerospace, and transportation industries. More specifically, the teachings of the present disclosure may find applicability in any industry having machines or equipment that include turbochargers.

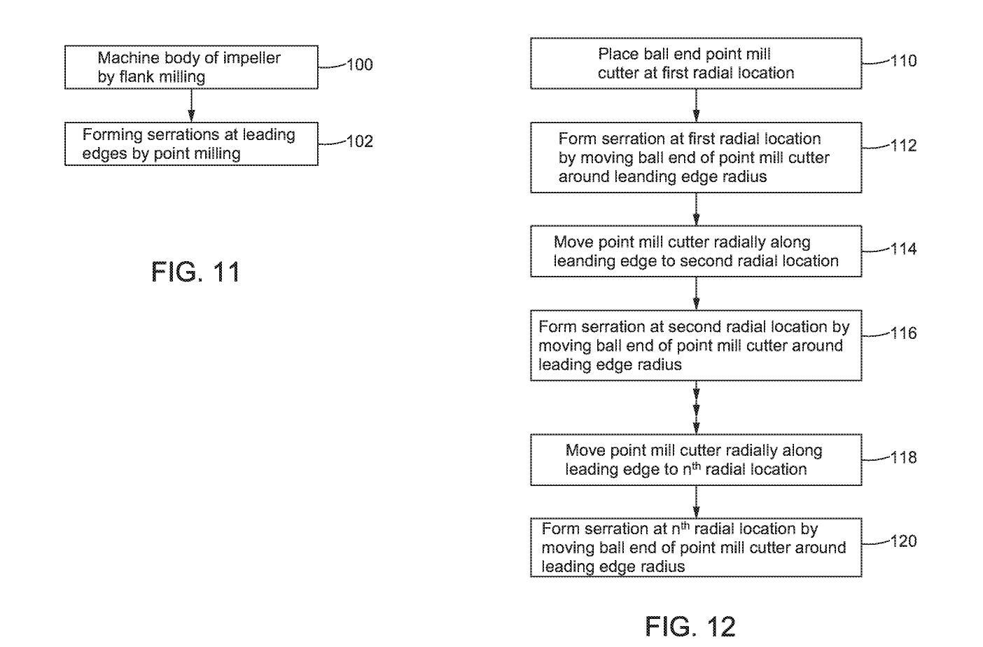

Referring to FIG. 11, a method that may be used to fabricate the radial impeller 20 with serrated leading edges is shown. The method may be carried out using the 5-axis milling machine 68 (see FIG. 6), although it may be carried out using another type of milling machine in other arrangements. At a first block 100, the body 34 (including the blades 24 and the hub 22) of the radial impeller 20 may be fabricated by flank milling. The block 100 may involve the roughening operation 80 that removes larger pieces from the workpiece 74, followed by the first finishing operation 82 to machine finer details of the body 34 of the radial impeller 20. Notably, during the block 100, the main blades 36 may be machined with slightly elongated leading edges. At a next block 102, the serrations 50 along the leading edges 38 may be formed by point milling. The block 102 may involve exchanging the flank mill cutter 76 in the 5-axis machine 68 with the point mill cutter 77, and performing the second finishing operation 84 with the point mill cutter 77. During the block 102, the leading edges 38 of the main blades 36 may be shortened as the serrations 50 are machined with the point mill cutter 77.

FIG. 12 shows a series of steps that may be involved in forming the serrations 50 along the leading edges 38 by point milling. At a first block 110, the ball end 88 of the point mill cutter 77 may be placed in contact with the leading edge 38 at the first radial location 92. According to a next block 112, the serration 50 may then be formed at the first radial location 92 by moving the ball end 88 of the point mill cutter 77 around the radius of the leading edge 38 in one or more passes 94 (see FIG. 10). Once the serration 50 is formed at the first radial location 92, the point mill cutter 77 may be shifted radially to the second radial location 96 immediately adjacent to the first radial location 92 (block 114) (also see FIG. 9). Another one of the serrations 50 may be formed at the second radial location 96 by moving the ball end 88 of the point mill cutter 77 around the radius of the leading edge 38 in one or more passes 94 (block 116). The steps of moving the point mill cutter 77 along the leading edge 38 to different radial locations and forming a serration at each radial location may be repeated until the desired number (n) of the serrations 50 having been formed along the leading edge 38 (blocks 118 and 120). While machining the serrations 50, the point mill cutter 77 may move radially inward from the shroud end 46 to the hub end 48 (see FIG. 9), or radially outward from the hub end 48 to the shroud end 46. Furthermore, the point mill cutter 77 may not move to radial locations near the shroud end 46 and/or the hub end 48 to leave portions of the leading edge 38 near the shroud end 46 and/or the hub end 48 non-serrated (see FIG. 4). Upon completion of the desired number (n) of serrations along the leading edge 38, the machine 68 may index to the next leading edge 38 of the impeller 20 and the process of FIG. 12 may repeat at the next leading edge 38. It will be understood that the process of FIG. 12 may also be carried out to machine the serrations 64 along the leading edges 60 of the splitter blades 58.

The compressor impeller of the present disclosure includes serrations along the leading edges of the main blades. The serrations may create counter-rotating vortices that flow along the surfaces of the main blades to prevent flow separation. Consequently, the surge behavior of the compressor may be softened with the serrations, possibly expanding the operating range of the compressor and reducing surge-induced noise. Serrations along the leading edges of the splitter blades may also be present in some embodiments, and may further contribute to softening of the surge behavior of the compressor. The compressor impeller of the present disclosure may be fabricated using a 5-axis milling machine, with the body of the impeller being machined using flank milling according to current procedures with a modification for slightly elongated blade leading edges. The elongated leading edges may be shortened to an appropriate length as the serrations are machined in an additional finishing step by point milling. Accordingly, point milling may only be used in a final finishing step to install the leading edge serrations, with the majority of the radial impeller being machined by flank milling.

It is expected that the technology disclosed herein may find applicability in a wide range of areas such as, but not limited to, automotive, aerospace, marine, and other machine applications.

What is claimed is:

1. A turbocharger, comprising:
a turbine;
a compressor having a radial impeller, the radial impeller including a hub and a plurality of main blades extending from the hub, each of the main blades having a leading edge;
a plurality of serrations extending along the leading edge of each of the main blades; and
a shaft interconnecting the compressor and the turbine.

2. The turbocharger of claim 1, wherein the radial impeller further includes a plurality of splitter blades extending from the hub that alternate in sequence with the plurality of main blades, and wherein the splitter blades have non-serrated leading edges.

3. The turbocharger of claim 1, wherein the radial impeller further includes a plurality of splitter blades extending from the hub that alternate in sequence with the plurality of main blades, and wherein each of the splitter blades includes a leading edge with a plurality of serrations.

4. The turbocharger of claim 1, wherein the serrations have a uniform shape.

5. The turbocharger of claim 4, wherein the serrations extending along the leading edge are immediately adjacent to each other.

6. The turbocharger of claim 5, wherein each of the serrations have a radius of less than about 1 millimeter.

7. The turbocharger of claim 6, wherein each of the serrations have a radius of about 0.5 millimeter.

8. The turbocharger of claim 6, wherein the leading edge of each of the main blades extends between a shroud end and a hub end, and wherein the leading edge is non-serrated near the hub end.

9. The turbocharger of claim 8, wherein the leading edge is non-serrated near the shroud end.

10. The turbocharger of claim 9, wherein the serrations extending along the leading edge begin about 0.5 millimeter radially inward from the shroud end and end about 2 to 3 millimeters radially outward from the hub end.

11. A radial impeller for a turbocharger compressor, the radial impeller having a body including a hub and a plurality of main blades extending from the hub, each of the main blades having a leading edge extending from a shroud end to a hub end, the radial impeller being fabricated by a method comprising:
machining the body of the radial impeller by flank milling; and
forming serrations extending along each of the leading edges of the main blades by point milling.

12. The radial impeller of claim 11, wherein machining the body of the radial impeller by flank milling comprises forming the main blades with elongated leading edges.

13. The radial impeller of claim 12, wherein forming the serrations extending along each of the leading edges of the main blades by point milling comprises shortening the leading edges by point milling.

14. The radial impeller of claim 13, wherein forming the serrations extending along each of the leading edges of the main blades by point milling further comprises forming the serrations such that the serrations are immediately adjacent to each other and have a uniform shape.

15. The radial impeller of claim 14, wherein forming the serrations extending along each of the leading edges of the main blades by point milling further comprises:
forming one of the serrations at a first radial location of the leading edge by moving a ball end of a point mill cutter around a radius of the leading edge;
moving the point mill cutter radially along the leading edge from the first radial location to a second radial location; and
forming another one of the serrations at the second radial location by moving the ball end around the radius of the leading edge at the second radial location.

16. The radial impeller of claim 15, wherein forming the serrations extending along each of the leading edges of the main blades by point milling further comprises forming the serrations such that the serrations have a radius of less than 1 millimeter.

17. The radial impeller of claim 16, wherein the ball end of the point mill cutter has a diameter of about 1 millimeter.

18. The radial impeller of claim 16, wherein forming the serrations extending along each of the leading edges of the main blades comprises forming the serrations along the leading edge from about 0.5 mm radially inward of the shroud end to about 2 to 3 millimeters radially outward from the hub end such that the leading edge is non-serrated near the shroud end and the hub end.

19. A method of fabricating a radial impeller for a turbocharger compressor, the radial impeller having a body including a hub and a plurality of main blades extending from the hub, the method comprising:
machining the body of the radial impeller by flank milling; and
forming serrations extending along the leading edges of each of the main blades by point milling, the flank milling and the point milling being carried out using a 5-axis milling machine.

20. The method of claim 19, wherein:
machining the body of the radial impeller by flank milling includes a roughening operation and a first finishing operation; and
forming the serrations extending along the leading edges of the main blades by point milling comprises a second finishing operation.
